(19) United States
(12) Patent Application Publication
(10) Pub. No.: US 2011/0108518 A1
(43) Pub. Date: May 12, 2011

(54) METHOD AND DEVICE FOR COATING A PERIPHERAL SURFACE OF A SLEEVE CORE

(75) Inventors: Luc Vanmaele, Lochristi (BE); Eddy Daems, Herentals (BE)

(73) Assignee: AGFA GRAPHICS NV, Mortsel (BE)

(21) Appl. No.: 13/002,656

(22) PCT Filed: Jul. 6, 2009
(86) PCT No.: PCT/EP2009/058515

§ 371 Date: Jan. 5, 2011

Related U.S. Application Data
(60) Provisional application No. 61/080,291, filed on Jul. 14, 2008.

(30) Foreign Application Priority Data
Jul. 10, 2008 (EP) 08104707.8

(51) Int. Cl. B44C 1/22; B01J 19/12; C08F 2/48; B05C 5/00

(52) U.S. Cl. 216/10; 427/457; 427/508; 427/595; 118/620

(57) ABSTRACT

A method of coating a peripheral surface of a sleeve core with a radiation curable coating liquid including the steps of: supporting a sleeve core in a vertical position coaxial with a coating axis; providing an annular coating collar, supplying the coating liquid to the annular coating collar and moving the annular coating collar along the sleeve core in a vertical direction coaxial with the coating axis, thereby coating a layer of the coating liquid onto the peripheral surface of the sleeve core; wherein the coated layer of the coating liquid is cooled by the peripheral surface of the sleeve core to have a viscosity at the temperature of the peripheral surface of the sleeve core and at a shear rate of 10 s⁻¹ which is larger than a minimum viscosity ηₘᵢₙ, with:

$${η}_{min} = \frac{{d}^{2}}{50}$$

wherein d represents the thickness of the coated layer expressed in μm, and ηₘᵢₙ is expressed in mPa·s. Also, a coating device for performing the above coating method.

### BACKGROUND OF THE INVENTION

1. Field of the Invention

The present invention relates to an apparatus and a method for coating a sleeve core with a single or a multitude of uniform layers of a coating liquid.

2. Description of the Related Art

Flexography is commonly used for high-volume runs of printing on a variety of supports such as paper, paperboard stock, corrugated board, films, foils and laminates. Packaging foils and grocery bags are prominent examples.

Flexographic printing forms are today made by both analogue imaging techniques such as a UV exposure through a mask, e.g. U.S. Pat. No. 6,521,390 (BASF), and digital imaging techniques which includes laser engraving on flexographic printing form precursors, e.g. US 2004/0259022 (BASF), and inkjet printing e.g. EP 1428666 A (AGFA) and US 2006/0055761 (AGFA).

Two main types of flexographic printing forms can be distinguished: a sheet form and a continuous cylindrical form. Continuous printing forms provide improved registration accuracy and lower change-over-time on press. Furthermore, such continuous printing forms may be well-suited for mounting on laser exposure equipment, where it can replace the drum, or be mounted on the drum for exposure by laser. Continuous printing forms have applications in the flexographic printing of continuous designs such as in wallpaper, decoration, gift wrapping paper and packaging.

Sleeves are made by applying an elastomeric layer onto a plastic or metallic cylinder, or winding a rubber ribbon around a plastic or metallic cylinder followed by a vulcanizing, grinding and polishing step. The forms preferable are seamless forms. As an alternative the elastomeric layer may be first applied on a flat support, which is then bent onto the carrier and bonded (see NYLOFLEX® Infinity Technology from BASF).

At the print media fair DRUPA held in 2004 in Germany, Asahi showed a prototype of the Adless digital engraving technology for endless photopolymer sleeves for digital engraving. It allows a liquid photopolymer material to be continually coated onto a sleeve/cylinder in a short time. The working principles of the technology are disclosed in JP 2003-241397 (ASAHI CHEMICAL). The Adless system is based on a horizontal coating stage to apply a photopolymer coating onto a sleeve core. The gap between the sleeve core's peripheral surface and the coating stage is gradually increased, while rotating the sleeve core, to increase the thickness of the applied photopolymer coating layer. After coating, the coated material is cured through photo-polymerization or photo-crosslinking. A post-curing step of grinding and polishing the cured photopolymer layer is required to provide surface characteristics, such as evenness, to the photopolymer layer necessary for flexographic printing sleeves. The post-treatment step after curing is required because of photopolymer unevenness and at least the presence of a polymer bulge left behind at the location where the coating stage was withdrawn from the sleeve while breaking off the coating process. The required grinding and polishing post-treatment and the large floor space required, seen the horizontal position of the coating system, are disadvantages.

Some vertical coating devices which reduce the required floor space have been suggested. JP 55-106567 (CANON) discloses a vertical coating method and device for uniformly coating a setting paint onto a drum, fixing the paint onto the drum by providing low hardening energy and hardening the fixed paint onto the drum by providing high hardening energy. The coating vessel and the equipment for providing the low and high hardening energy are fixedly mounted. The drum that is to be coated is attached to a lifting and lowering mechanism for vertically immersing the drum into the coating vessel respectively pulling up the drum out of the vessel and transporting the drum past an annular low hardening energy device and then in front of a vertical high hardening energy device. The device is suitable for the coating of drums limited in size (both length and diameter): (1) the length of the drum is limited to less than half the height of the equipment and less than the height of the vertical high hardening energy device, and (2) the diameter of the drum is limited by the dimensions of coating vessel and the diameter of the annular low hardening energy device.

U.S. Pat. No. 4,130,084 (STORK BRABANT) discloses a vertical ring coater having an annular receptacle containing a coating liquid and arranged coaxial with a vertically positioned sleeve. A layer of coating liquid is applied on the periphery of the sleeve during axial movement of the annular receptacle along the vertically positioned sleeve. The layer of coating liquid is dried via heat energy provided via the mounting flanges of the sleeve.

WO 2008/034810 A (AGFA GRAPHICS) discloses a coating device for coating a peripheral surface of a sleeve core with a coating formulation. The coating device is characterised by having an irradiation stage moveable with the annular coating stage, for providing radiation to at least partially cure the layer of coating formulation onto the peripheral surface so as to prevent flow down of the coating formulation. The movable irradiation stage is positioned in close proximity to the annular coating stage, which results in stray light causing undesired polymerization of the coating formulation not coated on the peripheral surface of a sleeve body. The effect of this undesired polymerization is that the evenness of the coated layer deteriorates during intensive use of the coating device and a time-consuming cleaning operation becomes necessary. Positioning the movable irradiation stage further away from the annular coating stage results in flow down of the coating formulation, requiring again a grinding and polishing post-treatment.

A need exists for a coating device suitable for making flexographic printing sleeves for direct laser engraving, which has limited floor space requirements, eliminates a grinding and polishing post-treatment of the sleeve, and reduces the access time and production cost of direct laser engraveable sleeves.

### SUMMARY OF THE INVENTION

Preferred embodiments of the present invention provide a coating method, suitable for making flexographic printing sleeves, which is capable of coating layers exhibiting uniform thickness, surface evenness, surface homogeneity and surface topology, without the need for grinding and polishing the sleeve afterwards and without time-consuming cleaning operation of a coating device

Other preferred embodiments of the present invention provide a coating device with limited floor space requirements, suitable for performing the above coating method.

Further advantages and benefits of the present invention will become apparent from the description hereinafter.

In the vertical coating of a layer of a radiation curable coating liquid, it was found that a relatively low viscosity is required to apply the coating at acceptable coating speeds, while a relatively high viscosity is required to prevent flow down of the coated layer. In preferred embodiments the present invention, this contradistinction was solved by coating a layer of a radiation curable coating liquid on a cooled peripheral surface of a sleeve core. A sufficient temperature decrease leads to a sharp increase of the viscosity of the coated liquid, thereby minimizing flow down. This allows positioning a movable irradiation stage further away from the annular coating stage without exhibiting flow down of the coating liquid or requiring a grinding and polishing post-treatment. In some cases, e.g. short sleeves and large increase in viscosity of the coated liquid, it becomes possible to perform the irradiation stage off-line, i.e. after removing the sleeve from the coating device.

Advantages and benefits of the present invention are realized with a coating method described below.

Advantages and benefits of the present invention are also realized with a coating device described below.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows a vertical ring coater known from the prior art.

FIG. 2 shows a coating device incorporating a cooling device.

FIG. 3 shows a preferred embodiment of the invention incorporating an annular irradiation stage.

### DETAILED DESCRIPTION OF THE PREFERRED EMBODIMENTS

### Coating Devices

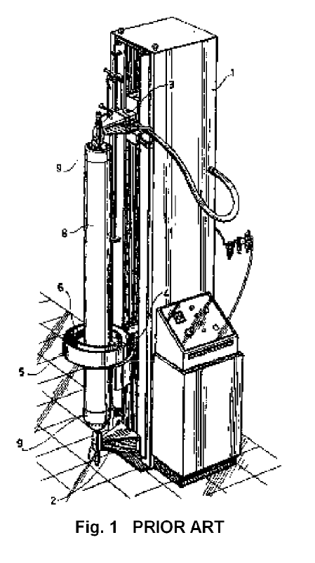

Preferred embodiments of the present invention may be engrafted on any equipment suitable for positioning a sleeve core in a vertical position and having a tool smoothly moveable along the sleeve core in the vertical direction. Examples of such equipment are vertical ring coaters described in the prior art or commercially available from Max Daetwyler Corporation (Switzerland) and the Stork Prints Group (The Netherlands). The description of preferred embodiments of the present invention will therefore not elaborate on the basic features of this type of equipment. Only in summary, a vertical ring coater as shown in FIG. 1 may include a vertical support column 1 that supports the sleeve core 8 in a vertical position, incorporates a mechanism 4 for lifting and lowering a coating carriage 5 vertically along the sleeve core 8, and provides a space envelope for integrating a number of utilities such as power cabling etc. The coating carriage 5 supports a coating collar 6 that is filled with a radiation curable coating liquid for coating onto the sleeve core 8. The sleeve core 8 is mounted in the vertical position by means of flanges or mounting heads 9 at both ends; the flanges or mounting heads 9 themselves are supported on the vertical support column 1. The flanges or mounting heads 9 may be shaped so as to provide a smooth extension of the sleeve core's peripheral surface, thereby allowing coating of the sleeve core 8 up to edges and also providing a sealed home position for the annular coating collar 6 at one of the flanges or mounting heads 9. The sleeve core 8 may be coated during an upward or downward movement of the coating collar 6.

When the coating collar 6 moves downward during the coating process, the coating layer is created from the meniscus between the liquid surface of the radiation curable coating liquid contained in the coating collar 6, and the peripheral surface of the sleeve core 8. In general, the thickness of the coating layer applied with this type of immersion coating technique is determined by the formula:

$$d = 20 * \sqrt{\frac{η * v}{f}} \qquad ( Eq . 1 )$$

wherein d equals the thickness of the coated layer in μm, η is the viscosity of the radiation curable coating liquid in mPa·s, v is the coating velocity in m·min⁻¹, and f is the specific density in kg/Liter. More details on Equation 1 can be found in “LIQUID FILM COATING” from Stephan F. Kistler and Peter M. Schweizer, Chapman & Hall 1997, 1^{st} Edition, incorporated herein as a specific reference.

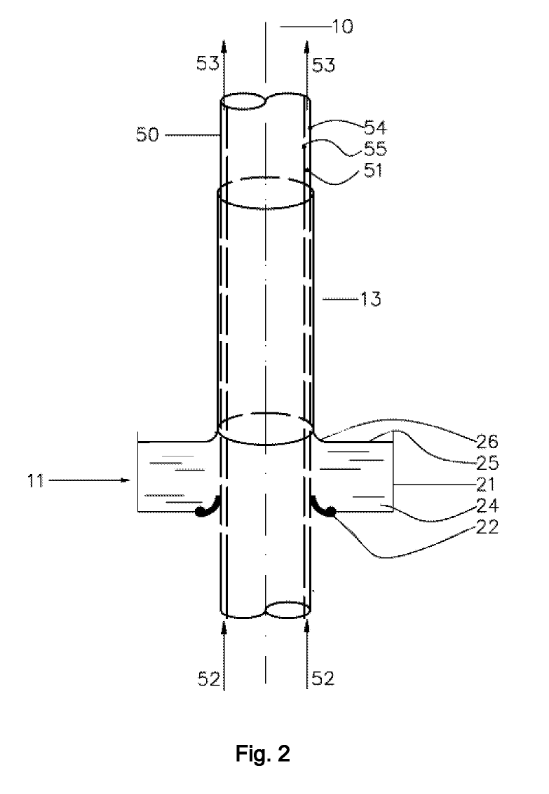

A preferred embodiment of the invention is now described in detail, with reference to FIG. 2. The coating collar 21 in FIG. 2 includes an annular squeegee 22 providing a slideable seal between the bottom of the coating collar 21 and the sleeve core 13, in order to prevent a radiation curable coating liquid 24 contained in the coating collar 21 to leak from the coating collar 21. The coating collar 21 is open at the top. The liquid surface 25 of the coating liquid 24 contained in the coating collar 21 forms an annular meniscus 26 with the peripheral surface of the sleeve 13. The coating collar 21 may be supported by a coating carriage (e.g. coating carriage 5 in FIG. 1) that is connected to a lifting and lowering mechanism (e.g. lift mechanism 4 in FIG. 1) incorporated in a vertical support column (e.g. column 1 in FIG. 1). These features have been omitted in FIG. 2. The lifting and lowering mechanism can move the entire coating stage 11, i.e. the assembly of the coating carriage with the coating collar, up and down along a vertical axis. When a sleeve core 13 is mounted, the lifting and lowering mechanism is capable of moving the annular coating stage 11 along the peripheral surface of the sleeve core 13, providing a coating meniscus 26 at the top and a sealing contact at the bottom of the coating collar 21. The coating axis 10 refers to the vertical axis through the centre of the coating collar 21 and coinciding with the axis of the sleeve core 13 when mounted on the coating device. The coating collar 21 moves up and down, centred round the coating axis 10.

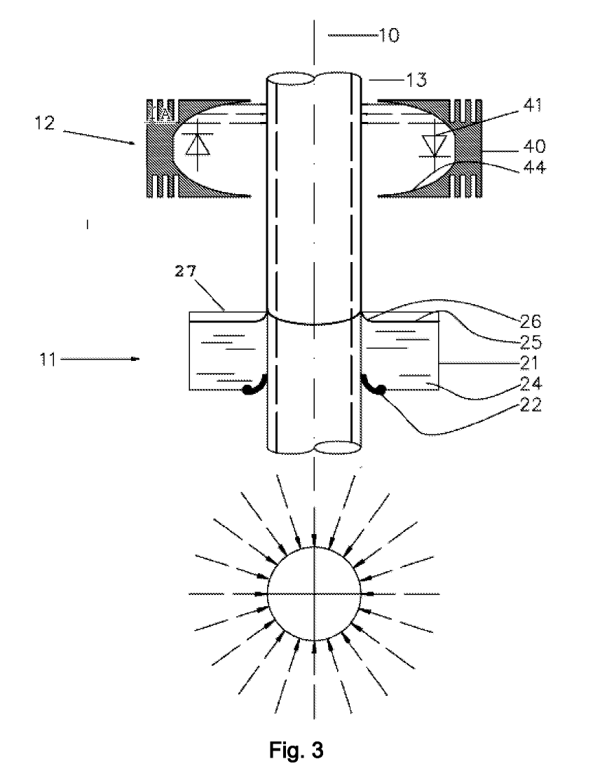

In a more preferred embodiment of a coating device as shown in FIG. 3, which is a coating device coating in a downward movement, some distance above the annular coating stage 11, an annular irradiation stage 12 is mounted. The purpose of the irradiation stage 12 is to partially or fully cure the coated layer, just applied by the annular coating collar 21, and to prevent the coating liquid from flow down. Flow down of the coated layer decreases the layer thickness at upper locations and increases the layer thickness at lower locations along the sleeve core 13, thereby decreasing the topographic uniformity of the layer and therefore the quality of the applied coating.

The terms “partial cure” and “full cure” refer to the degree of curing, i.e. the percentage of converted functional groups, and may be determined by, for example, RT-FTIR (Real-Time Fourier Transform Infra-Red Spectroscopy) which is a method well known to the one skilled in the art of curable formulations. A partial cure is defined as a degree of curing wherein at least 5%, preferably 10%, of the functional groups in the coated formulation is converted. A full cure is defined as a degree of curing wherein the increase in the percentage of converted functional groups, with increased exposure to radiation (time and/or dose), is negligible. A full cure corresponds with a conversion percentage that is within 10%, preferably 5%, from the maximum conversion percentage defined by the horizontal asymptote in the RT-FTIR graph (percentage conversion versus curing energy or curing time).

In WO 2008/034810 (AGFA GRAPHICS) the annular radiation stage 12 is mounted on top of the coating collar 21 because it is advantageous to cure the coated layer right after application onto the sleeve core 13. However, deterioration in the uniform thickness, surface evenness, surface homogeneity and surface topology of the coated layers is an issue when the coating device is repeatedly used for a long duration without a time-consuming cleaning operation of the coating collar 21. Stray light from the annular irradiation stage 12 causes polymerization of the radiation curable coating liquid 24 leading to sludge deposition on the sleeve core 13 and on the annular squeegee 22. This sludge deposition leads to surface defects of the coated layer. Positioning the annular radiation stage 12 further away reduces the surface defects caused by sludge deposition (decrease of stray light), but on the other hand deteriorates the uniform thickness of the coated layer by flow down of the coated layer.

This problem was solved in preferred embodiments of the present invention by providing a cooling device 50 in the coating device (see FIG. 2) whereby the coated layer of the coating liquid 24 is cooled by the peripheral surface of the sleeve core 13 having a temperature which is at least 10° C. lower than the temperature of the coating liquid. The annular radiation stage 12 can then be positioned further away from the annular coating stage 11 thereby minimizing stray light and surface defects. In some cases it is even possible to perform the irradiation stage off-line, i.e. after removing the sleeve core 13 with coating layer from the coating device, without problems of flow down of the coated layer.

Any cooling device suitable for cooling the peripheral surface of the sleeve core 13 to a temperature which is preferably at least 10° C. lower than the temperature of the coating liquid may be used. For example cold air can be blown onto the peripheral surface of the sleeve core 13 just prior to coating of the coating liquid 24. A disadvantage of this cooling method is that the temperature of the peripheral surface of the sleeve core 13 does not remain constant but increases gradually until a steady state is reached having a temperature between the temperature of the peripheral surface of the sleeve core and the coating temperature of the coating liquid.

In a preferred embodiment (see FIG. 2), the sleeve core 13 is supported in the coating device by a thin walled drum through which a cooling fluid 51 is circulated against the peripheral drum surface 54. The cooling fluid, e.g. cold water or cold diethylene glycol, is pumped via the cooling fluid inlet 52 into the space between the inner wall 55 of the drum and the drum surface 54 and recuperated via the cooling fluid outlet 53 in order to be cooled again.

In a preferred embodiment, the irradiation stage 12 is 360° all round and based on the use of UV LEDs and concentrating or collimating optics. UV LED's have several advantages compared to UV arc lamps, such as their compactness, acceptable wavelength and beam stability, good dose uniformity and a large linear dose regulation range. A disadvantage of the UV LED's is their relative low power output. UV LEDs however are relatively small and can be grouped together in such a way that their combined power is sufficient to cover the required UV curing range for different types of coating liquids and different thicknesses of coating layer.

In another embodiment, a rotating irradiation stage is used instead of an annular irradiation stage. In this case, the irradiation stage is not all round annular, but includes one or more distinct circular irradiation sectors, one or more linear irradiation segments or singular irradiation units, the invention requires the irradiation stage to spin around the sleeve in order to achieve a uniform irradiation all round the coated layer.

A cross-sectional view of a preferred embodiment of an annular irradiation stage is illustrated in FIG. 3 and shows a LED 41 positioned at the focal point of a parabolic reflecting cavity 44 of a collimator base 40.

In the embodiments described so far the irradiation source, e.g. an individual LED or an annular LED array, was linked to a corresponding collimating optics, e.g. a paraboloidal reflector respectively an annular collimating optics, and was considered one assembly. In an alternative embodiment the optics may be omitted in which case the LED radiation source directly irradiates the peripheral surface of the coated sleeve. Rotation of the irradiation source may provide additional integration and averaging of the radiation energy. In another alternative embodiment a non-rotating annular collimating optics may be combined with a rotating radiation source. In this configuration, the radiation source orbits between the peripheral surface of the sleeve core and the annular collimating optics. The irradiation tunnel, the specific annular and rotating irradiation stages, including those using laser beams for curing, disclosed in WO 2008/034810 (AGFA GRAPHICS) may be used in the present invention. WO 2008/034810 (AGFA GRAPHICS) is incorporated herein as a specific reference for the irradiation stage and also as a specific reference for the inertization environment. In applications using free radical UV curable formulations, it is known that the curing may be retarded or even not initiated due to the presence of oxygen in the cure zone. An inertization environment eliminates or minimizes the amount of inhibiting oxygen at the surface of the coated layer within the UV cure zone.

In a preferred embodiment of coating method according to the present invention, the actinic radiation is delivered by one or more laser beams or by a plurality of light emitting diodes.

From Eq.1 we know that the viscosity of the coating liquid is an important parameter in controlling the thickness of the applied layer. It is therefore preferred to shield the radiation curable coating liquid in the coating collar from any sources that may have a direct or indirect impact on the viscosity of the coating liquid. The coating device according to a preferred embodiment of the invention therefore preferably includes a radiation lock 27 (see FIG. 3) positioned between the radiation stage and the coating stage, and moveable therewith, for shutting off direct and indirect, e.g. scattered, radiation of the radiation source from the coating liquid contained in the coating collar. The radiation lock 27 is preferably annular shaped and may for example be realized by providing a cover to the coating collar reservoir. A more advanced radiation lock would be an adjustable iris diaphragm as used in optics, the diaphragm opening being adjusted to be slightly larger than the diameter of the sleeve to be coated. The annular radiation lock 27 may be mechanically integrated in the coating stage, in the irradiation stage or as a separate unit in between both stages. Even with a radiation lock present in the coating device, stray light is still capable of producing surface defects caused by sludge deposition.

### Coating Methods

The method of coating a peripheral surface of a sleeve core 13 with a radiation curable coating liquid 24 according to a preferred embodiment of the present invention includes the steps of:

supporting a sleeve core 13 in a vertical position coaxial with a coating axis 10;

providing an annular coating collar 21, supplying the coating liquid 24 to the annular coating collar 21 and moving the annular coating collar 21 along the sleeve core 13 in a vertical direction coaxial with the coating axis 10, thereby coating a layer of the coating liquid 24 onto the peripheral surface of the sleeve core 13;

wherein the coated layer of the coating liquid 24 is cooled by the peripheral surface of the sleeve core 13 to have a viscosity at the temperature of the peripheral surface of the sleeve core and at a shear rate of 10 s⁻¹ which is larger than a minimum viscosity ηₘᵢₙ,
with:

$${η}_{min} = \frac{{d}^{2}}{50} \qquad ( Eq . 2 )$$

wherein,
d represents the thickness of the coated layer expressed in μm, and
ηₘᵢₙ is expressed in mPa·s.

The laminar flow of a falling film is well described on pages 42 to 48 in paragraph 2.2 of Chapter 2 “Shell Momentum Balances and Velocity Distribution in Laminar Flow” in the book “Trans port Phenomena”, Second Edition, Byrd R. B. et al., John Wiley & Sons, Inc, USA, 2002 (ISBN 0-471-41077-22) incorporated herein as reference. The velocity of a falling film of a coating liquid is described by a relationship between the squared thickness of the film and the viscosity of the coating liquid. However, in the present case of vertical coating of the radiation curable liquid, the flow down is not a laminar flow, since the occurrence of a bulge is observed. Through experimentation, a minimal viscosity ηₘᵢₙ could be identified above which a smooth coated layer was obtained allowing sufficient time before curing by an irradiation stage became necessary in order to prevent the flow down of the coating liquid or the requirement of a grinding and polishing post-treatment. This allows positioning a movable irradiation stage further away from the annular coating stage or even performing the irradiation stage off-line, i.e. after removing the sleeve from the coating device. The viscosity ηₘᵢₙ is also a function of the squared thickness of the coated film and is described by the equation Eq.2 above.

The coated layer typically has a thickness from 500 μm to 1.5 mm for thin sleeves but may be as high as 10 mm for other sleeves. Depending on the application, the relief depth of a flexographic printing master varies from 0.2 to 4 mm, preferably from 0.4 to 2 mm. Hence, the coated layer for making a flexographic printing master preferably has a thickness between 500 μm and 6 mm. The minimum viscosity ηₘᵢₙ required at the temperature of the peripheral surface of the sleeve core and at a shear rate of 10 s⁻¹ is shown for a number thicknesses of the coated layer in Table 1.

TABLE 1

| | | Minimum | |
|---|---|---|---|
| Thickness of the | | viscosity | |
| coated layer d | | ηₘᵢₙ | |
| 200 | μm | 800 | mPa · s |
| 400 | μm | 3.2 | Pa · s |
| 600 | μm | 7.2 | Pa · s |
| 800 | μm | 12.8 | Pa· s |
| 1 | mm | 20.0 | Pa · s |
| 2 | mm | 80.0 | Pa · s |
| 3 | mm | 180.0 | Pa · s |
| 4 | mm | 320.0 | Pa · s |

In a preferred embodiment, the peripheral surface of the sleeve core 13 has a temperature which is preferably at least 10° C. lower than the temperature of the coating liquid and more preferably at least 15° C. lower than the temperature of the coating liquid.

The peripheral surface of the sleeve core 13 preferably has a temperature above the dew point. The dew point is the temperature to which air must be cooled, at constant barometric pressure, for water vapor to condense into water. The condensed water is called dew. The dew point is a saturation point. When the dew point temperature falls below freezing it is often called the frost point, as the water vapor no longer creates dew but instead creates frost by deposition. The dew point is associated with relative humidity. A high relative humidity indicates that the dew point is closer to the current air temperature; if the relative humidity is 100%, the dew point is equal to the current temperature.

Below the dew point, condensation of water onto the peripheral surface of the sleeve core 13 may cause problems such as coating defects and curing problems especially when a cationically curable coating liquid 24 is used. Temperatures below the dew point can be used but require costly adaptation of the coating device to avoid condensation of water onto the peripheral surface of the sleeve core 13.

In a preferred embodiment the peripheral surface of the sleeve core 13 may be kept at room temperature, while the coating liquid is heated to a temperature of preferably at least 30° C., more preferably at least 35° C. and most preferably at least 40° C. The heating of the coating liquid may be performed by circulating the coating liquid over a heating device and then back to the annular coating collar 21, but preferably the coating liquid is heated inside the annular coating collar 21.

In another preferred embodiment of the present invention, the coating method combines cooling the peripheral surface of the sleeve core 13 with the heating of the coating liquid. The advantage of this combination is that the difference in temperature can be maximized without impairing the stability of the coating liquid while avoiding condensation of water when the peripheral surface of the sleeve core 13 is cooled to a temperature below the dew point. Radiation curable coating liquids kept at high temperature tend to loose stability due to e.g. thermal polymerization, which again leads to surface unevenness and surface defects caused by sludge deposition.

Instead of coating in one single pass, the coating device may also operate in a multiple pass mode with intermediate “curing” of the surface of each of the applied layers. The multiple pass coating may be mainly bidirectional or unidirectional.

Multiple pass operation of the coating device as described may be used for applying uniform thick layers of coating material onto sleeve cores. It may for example be used in cases where physico-chemical parameters of the coating liquid, e.g. viscosity, or limitations of the coating device, e.g. coating velocity, would limit the thickness of a coated layer as predicted from Eq.1 to a value below what is functionally required for the application. Especially for flexographic sleeves or printing masters, the relief-forming layer may require a thickness of several millimetres, which can be difficult to achieve in a single pass coating process.

Multiple pass operation of the coating device may also be used for applying a multitude of layers of different coating liquid formulations. The coating liquids may have different physicochemical properties, e.g. viscosity, or the corresponding coated layers may have different physicochemical or mechanical properties such as compressibility, hardness, wear-resistance, wettability. For the production of flexographic sleeves, it may be desirable to have a compressible base (suitable for absorbing for example the unevenness in corrugated board printing material) and a hard surface (for increased durability and suitable for longer print runs). If desired a complete physicochemical thickness profile may be created for the coated multilayer.

The flanges or mounting heads may require regular cleaning to remove coating liquid residues from end-to-end coating processes or linked with their use as home position for the coating collar. A coating liquid repelling layer on the flanges or mounting heads may facilitate this cleaning.

If a different size of sleeve is to be coated, different flanges or mounting heads may be installed and the annular seal of the coating collar may be changed or adjusted to match with the new sleeve diameter. An example of an adjustable annular seal is an adjustable iris diaphragm including overlapping sealing leaves wherein the diaphragm opening, i.e. the aperture, is adjustable through adjustment of the position of the leaves relative to each other, as known in photography. The higher the number of leaves in the iris diaphragm, the better the sealing property of the iris diaphragm around the peripheral surface of the sleeve.

The radiation curable coating liquid 24 used in the coating method according to a preferred embodiment of the present invention preferably has a viscosity at the coating temperature and at a shear rate of 10 s⁻¹ of preferably 100 to 50,000 mPa·s, more preferably 400 to 30,000 mPa·s, more preferably 500 to 20,000 mPa·s, and most preferably 1,000 to 10,000 mPa·s. Below a viscosity of 100 mPa·s, either multiple thin layers have to be applied thereby reducing the productivity of the coating device, or otherwise a very large temperature difference is necessary which results in a high energy consumption of the coating device and requires high thermal stability of the coating liquid. Above 50,000 mPa·s, the coating speed becomes impracticably low from an economical point of view. The coating temperature is the temperature of the coating liquid at coating and not the surface temperature of the sleeve core. The coating temperature of the liquid is preferably between 20° C. and 120° C., more preferably between 25° C. and 80° C., and most preferably between 40° C. and 60° C. The surface temperature of the sleeve core is preferably between 0° C. and 80° C., more preferably between 4° C. and 60° C., and most preferably between 20° C. and 40° C.

The radiation curable coating liquid 24 used in the coating method according to a preferred embodiment of the present invention is preferably coated at a coating speed between 0.01 and 20 m/min, more preferably at a coating speed between 0.05 and 10 m/min, and most preferably at a coating speed between 0.15 and 8 m/min,

### Radiation Curable Coating Liquids

The radiation curable coating liquid 24 is curable by actinic radiation which can be UV light, IR light or visible light. Preferably the radiation curable coating liquid is a UV curable coating liquid.

The radiation curable coating liquid preferably contains at least a photo-initiator and a polymerizable compound. The polymerizable compound can be a monofunctional or polyfunctional monomer, oligomer or pre-polymer or a combination thereof.

In a preferred embodiment of the present invention, the radiation curable coating liquid includes:

a) a photoinitiator;
b) an urethane (meth)acrylate oligomer with a viscosity of at least 1,000 mPa·s at 25° C. and at a shear rate of 10 s⁻¹; and
c) at least one (meth)acrylate based diluent.

The (meth)acrylate based diluent is preferably a monofunctional or difunctional (meth)acrylate. The urethane acrylate oligomer increases the flexibility of the cured coated layer of radiation curable coating liquid.

An elastomer or a plasticizer is preferably present in the radiation curable coating liquid for improving desired flexographic properties such as flexibility and elongation at break.

The radiation curable coating liquid may be a cationically curable coating liquid but is preferably a free radical curable coating liquid.

The radiation curable liquid may contain a polymerization inhibitor to restrain polymerization by heat or actinic radiation.

The radiation curable coating liquid may contain at least one surfactant for controlling the spreading of the coating liquid.

The radiation curable coating liquid may further contain at least one colorant for increasing contrast of the image on the flexographic printing master.

### Initiators

The radiation curable liquid may include one or more initiators. The initiator typically initiates the polymerization reaction. The initiator may be a thermal initiator, but is preferably a photo-initiator.

Thermal initiator(s) suitable for use in the curable resin composition include tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy)butane, 1,1-bis(tert-butylperoxy)cyclohexane, 1,1-Bis (tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peracetate, tert-butyl peroxide, tert-butyl peroxy benzoate, tert-butylperoxy isopropyl carbonate, cumene hydro peroxide, cyclohexanone peroxide, dicumyl peroxide, lauroyl peroxide, 2,4-pentanedione peroxide, peracetic acid and potassium persulfate.

A photo-initiator produces initiating species, preferably free radicals, upon absorption of actinic radiation. A photo-initiator system may also be used. In the photo-initiator system, a photo-initiator becomes activated upon absorption of actinic radiation and forms free radicals by hydrogen or electron abstraction from a second compound. The second compound, usually called the co-initiator, becomes then the initiating free radical. Free radicals are high-energy species inducing polymerization of monomers or oligomers. When polyfunctional monomers and oligomers are present in the curable resin composition, the free radicals can also induce crosslinking.

Curing may be realized by more than one type of radiation with different wavelength. In such cases it may be preferred to use more than one type of photo-initiator together.

A combination of different types of initiators, for example, a photo-initiator and a thermal initiator may also be used.

Suitable photo-initiators are disclosed in e.g. J. V. Crivello et al. in “Photoinitiators for Free Radical, Cationic & Anionic Photopolymerisation 2nd edition”, Volume III of the Wiley/SITA Series In Surface Coatings Technology, edited by G. Bradley and published in 1998 by John Wiley and Sons Ltd London, pages 276 to 294.

Specific examples of photo-initiators may include, but are not limited to, the following compounds or combinations thereof: quinones, benzophenone and substituted benzophenones, hydroxy alkyl phenyl acetophenones, dialkoxy acetophenones, α-halogeno-acetophenones, aryl ketones such as 1-hydroxycyclohexyl phenyl ketone, 2-hydroxy-2-methyl-1-phenyl propan-1-one, 2-benzyl-2-dimethylamino-(4-morpholinophenyl)butan-1-one, thioxanthones such as isopropylthioxanthone, benzil dimethylketal, bis(2,6-dimethyl benzoyl)-2,4,4-trimethylpentylphosphine oxide, trimethylbenzoyl phosphine oxide derivatives such as 2,4,6 trimethylbenzoyl diphenylphosphine oxide, methyl thio phenyl morpholine ketones such as 2-methyl-1-[4-(methylthio)phenyl]-2-morpholinopropan-1-one, morpholino phenyl amino ketones, 2,2-dimethoxy-1,2-diphenylethan-1-one, 5,7-diiodo-3-butoxy-6-fluorone, diphenyliodonium fluoride and triphenylsulfonium hexafluophosphate, benzoin ethers, peroxides, biimidazoles, aminoketones, benzoyl oxime esters, camphorquinones, ketocoumarins and Michler's ketone.

Suitable commercial photo-initiators include IRGACURE™ 127, IRGACURE™ 184, IRGACURE™ 500, IRGACURE™ 907, IRGACURE™ 369, IRGACURE™ 1700, IRGACURE™ 651, IRGACURE™ 819, IRGACURE™ 1000, IRGACURE™ 1300, IRGACURE™ 1800, IRGACURE™ 1870, DAROCUR™ 1173, DAROCUR™ 2959, DAROCUR™ 4265 and DAROCUR™ ITX available from CIBA SPECIALTY CHEMICALS, LUCERIN™ TPO available from BASF AG, ESACURE™ KK, ESACURE™ KT046, ESACURE™ KT055, ESACURE™ KIP150, ESACURE™ KT37 and ESACURE™ EDB available from LAMBERTI, H-Nu 470 and H-Nu 470X available from SPECTRA GROUP Ltd., GENOCURE™ EHA and Genocure™ EPD from RAHN.

Since curing is preferably realized with UV-radiation, the preferred photo-initiators absorb UV radiation.

To improve in depth curing, it may be advantageous to use an initiator system that decreases in UV absorbance as polymerization proceeds, as disclosed in US 2002/0123003 A (DU PONT) paragraph [0021].

Particular preferred photo-initiators are IRGACURE™ 651 and IRGACURE™ 127.

Suitable cationic photo-initiators include compounds, which form aprotic acids or Brönstead acids upon exposure sufficient to initiate polymerization. The photo-initiator used may be a single compound, a mixture of two or more active compounds, or a combination of two or more different compounds, i.e. co-initiators. Non-limiting examples of suitable cationic photo-initiators are aryldiazonium salts, diaryliodonium salts, triarylsulphonium salts, triarylselenonium salts and the like.

Sensitizing agents may also be used in combination with the initiators described above. In general, sensitizing agents absorb radiation at a wavelength different then the photo-initiator and are capable of transferring the absorbed energy to that initiator, resulting in the formation of e.g. free radicals.

The amount of initiator in the curable composition of a preferred embodiment of the present invention is preferably from 1 to 10% by weight, more preferably from 2 to 8% by weight, relative to the total weight of the ingredients of the radiation curable coating liquid.

### Polymerizable Compounds

The polymerizable compounds may include one or more polymerizable groups, preferably radically polymerizable groups.

Any polymerizable mono- or oligofunctional monomer or oligomer commonly known in the art may be employed. Preferred monofunctional monomers are described in EP1637322 A (AGFA) paragraph [0054] to [0057]. Preferred oligofunctional monomers or oligomers are described in EP1637322 A (AGFA) paragraphs [0059] to [0064].

The selection of polymerizable compounds determines the properties of the cured resin composition, e.g. flexibility, resilience, hardness, adhesion of the relief image.

A particularly preferred polymerizable compound is an urethane (meth)acrylate oligomer. It has been found that the presence of urethane (meth)acrylate oligomers, preferably in an amount of 40% by weight or more, relative to the total weight of the ingredients of the polymerizable coated layers, provides excellent printing properties to the flexographic sleeves. The urethane (meth)acrylate oligomer may have one, two, three or more polymerizable groups. Preferably the urethane (meth)acrylate oligomers have one or two polymerizable groups.

Commercially available urethane (meth)acrylates are e.g. CN9170, CN910A70, CN966H90, CN962, CN965, CN9290 and CN981 from SARTOMER; BR-3741B, BR-403, BR-7432, BR-7432G, BR-3042, BR-3071 from BOMAR SPECIALTIES CO.; NK Oligo U-15HA from SHIN-NAKAMURA CHEMICAL CO. Ltd.; ACTILANE™ 200, ACTILANE™ SP061, ACTILANE™ 276, ACTILANE™ SP063 from AKZO-NOBEL; EBECRYL™ 8462, EBECRYL™ 270, EBECRYL™ 8200, EBECRYL™ 285, EBECRYL™ 4858, EBECRYL™ 210, EBECRYL™ 220, EBECRYL™ 1039, EBECRYL™ 1259 and IRR160 from CYTEC; GENOMER™ 1122 and GENOMER™ 4215 from RAHN A.G. and VERBATIM™ HR50 an urethane acrylate containing liquid photopolymer from CHEMENCE.

Preferably, the radiation curable coating liquid includes also a silicone acrylate compound, such as e.g. EBECRYL™ 1360.

To optimize the viscosity of the radiation curable coating liquid forming the polymerizable layers, one or more mono and/or difunctional monomers and/or oligomers are used as diluents. Preferred monomers and/or oligomers acting as diluents are miscible with the above described urethane (meth)acrylate oligomers. Particularly preferred monomers and/or oligomers acting as diluents do not adversely affect the properties of the cured resin composition.

The monomer(s) or oligomer(s) used as diluents are preferably low viscosity acrylate monomer(s).

Particularly preferred monomers and/or oligomers acting as diluents in the radiation curable coating liquid of preferred embodiments of the present invention are: SR344, a polyethyleneglycol (400) diacrylate; SR604, a polypropylene monoacrylate; SR9003, a propoxylated neopentyl glycol diacrylate; SR610, a polyethyleneglycol (600) diacrylate; SR531, a cyclic trimethylolpropane formal acrylate; SR340, a 2-phenoxyethyl methacrylate; SR506D, an isobornyl acrylate; SR285, a tetrahydrofurfuryl acrylate all from SARTOMER or CRAY VALLEY; Miramer™ M100, a dicaprolactone acrylate and GENOMER™ 1122, a monofunctional urethane acrylate from RAHN; BISOMER™ PEA6, a polyethyleneglycol monoacrylate from COGNIS; EBECRYL™ 1039, a very low viscous urethane monoacrylate; EBECRYL™ 11, a polyethylene glycol diacrylate; EBECRYL™ 168, an acid modified methacrylate, EBECRYL™ 770, an acid functional polyester acrylate diluted with 40% hydroxyethylmethacrylate from UCB and CN137, a low viscosity aromatic acrylate oligomer from CRAYNOR.

### Inhibitors

In order to prevent premature thermal polymerization, the radiation curable coating liquid may contain a polymerization inhibitor. Suitable polymerization inhibitors include phenol type antioxidants, hindered amine light stabilizers, phosphor type antioxidants, hydroquinone monomethyl ether, hydroquinone, t-butyl-catechol or pyrogallol.

Suitable commercial inhibitors are, for example, SUMILIZER™ GA-80, SUMILIZER™ GM and SUMILIZER™ GS produced by Sumitomo Chemical Co. Ltd.; GENORAD™ 16, GENORAD™ 18 and GENORAD™ 20 from Rahn AG; IRGASTAB™ UV10 and IRGASTAB™ UV22, TINUVIN™ 460 and CGS20 from Ciba Specialty Chemicals; FLOORSTAB™UV range (UV-1, UV-2, UV-5 and UV-8) from Kromachem Ltd, ADDITOL™ S range (S100, S110, S120 and S130) from Cytec Surface Specialties.

Since excessive addition of these polymerization inhibitors will lower the curing efficiency, the amount is preferably lower than 2% by weight relative to the total weight of the ingredients of the polymerizable layers.

### Elastomers

To further optimize the properties of the flexographic printing master, the radiation curable coating liquid may further include one or more elastomeric compounds. Suitable elastomeric compounds include copolymers of butadiene and styrene, copolymers of isoprene and styrene, styrene-diene-styrene triblock copolymers, polybutadiene, polyisoprene, nitrile elastomers, polyisobutylene and other butyl elastomers, polyalkyleneoxides, polyphosphazenes, elastomeric polyurethanes and polyesters, elastomeric polymers and copolymers of (meth)acrylates, elastomeric polymers and copolymers of olefins, elastomeric copolymers of vinylacetate and its partially hydrogenated derivatives.

The type and amount of monomers and/or oligomers and optionally the elastomeric compounds are selected to realize optimal properties of the flexographic printing master such as flexibility, resilience, hardness, adhesion to the substrate and adhesion of the relief image.

### Plasticizers

Plasticizers are typically used to improve the plasticity or to reduce the hardness of the flexographic printing master. Plasticizers are liquid or solid, generally inert organic substances of low vapor pressure.

Suitable plasticizers include modified and unmodified natural oils and resins, alkyl, alkenyl, arylalkyl or arylalkenyl esters of acids, such as alkanoic acids, arylcarboxylic acids or phosphoric acid; synthetic oligomers or resins such as oligostyrene, oligomeric styrene-butadiene copolymers, oligomeric α-methylstyrene-p-methylstyrene copolymers, liquid oligobutadienes, or liquid oligomeric acrylonitrile-butadiene copolymers; and also polyterpenes, polyacrylates, polyesters or polyurethanes, polyethylene, ethylene-propylene-diene rubbers, α-methyloligo (ethylene oxide), aliphatic hydrocarbon oils, e.g., naphthenic and paraffinic oils; liquid polydienes and liquid polyisoprene.

Examples of particularly suitable plasticizers are paraffinic mineral oils; esters of dicarboxylic acids, such as dioctyl adipate or dioctyl terephthalate; naphthenic plasticizers or polybutadienes having a molar weight of between 500 and 5,000 g/mol.

More particularly preferred plasticizers are HORDAFLEX™ LC50 available from HOECHST, SANTICIZER™ 278 available from MONSANTO, TMPME available from PERSTORP AB, and PLASTHALL™ 4141 available from C. P. Hall Co.

It is also possible to use a mixture of different plasticizers.

Preferred plasticizers are liquids having molecular weights of less than 5,000, but can have molecular weights up to 30,000.

### Other Additives

The radiation curable coating liquid may further include other additives such as dyes, pigments, photochromic additives, anti-oxidants, biocides, antimicrobial additives, antiozonants and tack-reducing additives. Examples of tack-reducing additives are for example aromatic carboxylic acids, aromatic carboxylic acid esters, polyunsaturated carboxylic acids, and polyunsaturated carboxylic acid esters of mixtures thereof. The amount of additives is preferably less than 20% by weight based on the sum of all constituents of the radiation curable coating liquid, and is advantageously chosen so that the overall amount of plasticizer and additives does not exceed 50% by weight based on the sum of all the constituents.

### Liquid Photopolymers

Commercially available liquid photopolymers, e.g. VERBATIM™ liquid photopolymer resins from CHEMENCE, can be used as the radiation curable coating liquid.

A wide range of liquid photopolymer products are available, each product resulting upon coating and curing in layers having particular properties, e.g. different Shore A hardnesses. When the flexographic printing master is formed by more than one layer, different liquid photopolymers may be used in each different layer. The radiation curable coating liquids used to form the uniform layers onto the sleeve carrier may consist essentially of such a commercially available liquid photopolymer and a photo-initiator, such as e.g. IRGACURE™ 127. Preferably, these liquid photopolymers are used in combination with the diluent monomers and/or oligomers described above to optimize the viscosity of the radiation curable coating liquid.

### Flexographic Printing Masters

A method of making a flexographic printing master according to a preferred embodiment of the present invention includes the steps of

a) coating a peripheral surface of a sleeve core 13 with a radiation curable coating liquid 24 according to the coating methods described above; and
b) forming a relief onto or from the coated layer.

The flexographic printing master may be made on the coating device, but is preferably made on a separate apparatus.

If the coated layer is of a sufficient thickness, the flexographic printing master may be made directly from the coated layer on the sleeve core 13 by forming a relief using image wise exposure of the coated layer with actinic radiation or by laser engraving.

The flexographic printing master may be made by forming a relief using image wise exposure of the coated layer with actinic radiation. For example, an image is applied to the coated layer by flood exposing the radiation curable coated layer to actinic radiation (e.g. ultraviolet radiation) with an image mask interposed between the radiation source and the coated layer. The actinic radiation causes polymerization to occur in the areas of the radiation curable coated layer not shielded by the image mask. After imaging, the flexographic printing precursor sleeve is processed either with a suitable solvent or thermally to remove the radiation curable composition in the unexposed areas, thereby creating a relief-based image on the sleeve core.

Instead of using an image mask, the image may be directly applied by using a laser. The actinic radiation of the laser causes polymerization to occur in the exposed areas of the radiation curable coated layer. After imaging, the flexographic printing precursor sleeve is processed either with a suitable solvent or thermally to remove the radiation curable composition in the unexposed areas, thereby creating a relief-based image on the sleeve core.

In preparing conventional flexographic printing masters, a first step is a back exposure or backflash step of a flexographic printing precursor. This is a blanket exposure of actinic radiation through the support. It is used to create a layer of polymerized material, or an elastomeric floor, on the support side of the radiation curable layer.

In a preferred embodiments of the coating method of the present invention, especially for the above coating method using an image mask or image wise exposure by laser, an elastomeric floor can be created in several ways. For example, a similar backflash step can be performed by using a UV-transparent sleeve core 13 and a source of UV light located inside the sleeve core. Another possibility is to coat a first layer with the coating device, applying a full exposure with actinic radiation of the coated layer in order to obtain an elastomeric floor and then apply a second coated layer which can be used for image wise exposure to create a flexographic printing master. Alternatively the coated layer can also be applied to a previously off-line prepared elastomeric sleeve.

In a preferred embodiment of the present invention, the fully cured coated layer on the sleeve core can be directly laser engraved. In this laser mode, the energy applied by the laser is so large that it directly removes parts of the coated layer, thereby creating a relief-based image on the sleeve core.

The coated layer can also be used as an elastomeric floor. In preparing conventional flexographic printing masters, a first step is a back exposure or backflash step of a flexographic printing precursor. This is a blanket exposure of actinic radiation through the support. It is used to create a layer of polymerized material, or an elastomeric floor, on the support side of the radiation curable or photopolymerizable layer.

In a preferred embodiment the at least partially cured coated layer serves as an elastomeric floor for inkjet printing a relief thereon in the way as disclosed by e.g. EP 1428666 A (AGFA) and US 2006/0055761 (AGFA).

### EXAMPLES

### Materials

All materials used in the following examples were readily available from standard sources such as Aldrich Chemical Co. (Belgium) and Acros (Belgium) unless otherwise specified.

BR-2042, BR-7432 and BR-7432G are urethane acrylate oligomers from BOMAR SPECIALTIES.

SR531 is cyclic trimethylolpropane formal acrylate available as SARTOMER™ SR531 from SARTOMER.
SR285 is tetrahydrofurfuryl acrylate available as SARTOMER™ SR285 from SARTOMER.
SR340 is 2-phenoxyethyl methacrylate available as SARTOMER™ SR340 from SARTOMER.
CN131B is a low viscosity aromatic monoacrylate oligomer available as SARTOMER™CN131B from SARTOMER.
CN9001 is an aliphatic urethane acrylate oligomer available as SARTOMER™CRAYNOR CN 9001 from SARTOMER.
CN9200 is an aliphatic urethane acrylate oligomer available as SARTOMER™CRAYNOR CN 9200 from SARTOMER.
CN9800 is a urethane acrylate silicone available as SARTOMER™ CRAYNOR CN 9800 from SARTOMER.
GENOMER™ 1122 is 2-acrylic acid 2-(((acryl-amino)carbonyl)oxy)ethylester available from RAHN AG (Switzerland).
MIRAMER™ M100 is di-caprolactone acrylate from RAHN AG (Switzerland).
EBECRYL™ 1360 is a polysiloxane hexa acrylate from UCB S.A. (Belgium).
IRGACURE™ 651 is the photoinitiator 2,2-dimethoxy-1,2-diphenylethan-1-one from Ciba Specialty Chemicals (Belgium).

### Measurement

### 1. Viscosity

The viscosity was measured with a MCR500 Rheometer (manufacturer Anton Paar), equipped with a CC27 spindle and a coaxial cylinder geometry (shear rate 10 s⁻¹).

### 2. Flow Down Behaviour

The flow down behaviour of a coating liquid was determined by coating the coating liquid horizontally on an un-subbed glass plate at a certain thickness and then placing the coated glass plate in a vertical position and measuring the flow down displacement (in cm) of the border of the coated layer. The glass plate was kept at a constant temperature at all times.

### Example 1

This example illustrates that cooling the coated liquid by at least 10° C. allows the production of sleeves with coated layers of uniform thickness and surface evenness.

### Preparation of Coating Liquid

The radiation curable coating liquid LIQ-1 was prepared according to Table 2. The weight % (wt %) was based on the total weight of the radiation curable coating liquid.

TABLE 2

| wt % of | |
|---|---|
| Component | LIQ-1 |
| BR-3042 | 50 |
| SR531 | 10 |
| SR285 | 5 |
| SR340 | 8 |
| CN131B | 4 |
| GENOMER ™ | 8 |
| 1122 | |
| MIRAMER ™ | 8 |
| M100 | |
| EBECRYL ™ | 3 |
| 1360 | |
| IRGACURE ™ | 4 |
| 651 | |

Coating and evaluation of flow down behaviour of coating liquid LIQ-1

The coating liquid LIQ-1 was coated horizontally at a thickness of 600 μm and at room temperature (20° C.) on two un-subbed glass plates A and B with a thickness of 2 mm. Plate A was kept in a fridge at a temperature of 4° C. during 30 minutes before being coated. Immediately after being coated, plate A was placed in the fridge again (at 4° C.) and kept there in a vertical position. The flow down behaviour was followed in function of time.

The other glass plate B was kept at room temperature (20° C.) before and during the coating step. Plate B was put to the same test as plate A, but in this case the control on the flow down behaviour when put vertically was carried out at room temperature.

The results of the flow down behaviour are visualized in Table 3.

TABLE 3

Flow down
displacement (cm)

| Time after plate | Plate A | Plate B |
|---|---|---|
| been put vertically | (4° C.) | (20° C.) |
| (min) | Invention | Comparison |
| 1 | 0 | 3.0 |
| 2 | 0.5 | 6.0 |
| 3 | 1.5 | 9.0 |
| 4 | 2.5 | 12.0 |
| 5 | 3.5 | 16.0 |
| 10 | 8.0 | >16.0 |

As soon as plate B was put vertically, the uncured coated layer started to flow down and a fast flow down was observed until after 5 minutes the bottom border of the glass plate was reached. No flow down was observed until two minutes after plate A was put in a vertical position. Furthermore, no condensation of water was observed on plate A at 4° C.

The coating conditions of plate A allow a curing stage to be positioned further away from the coating stage while still delivering coated layers exhibiting uniform thickness and surface evenness, and without the need for a grinding and polishing post-treatment.

According to a preferred embodiment of the present invention, the minimum viscosity ηₘᵢₙ for a coated layer having a thickness of 600 μm is 7,200 mPa·s. At the temperature of the plate B at coating (20° C.), the radiation curable coating liquid LIQ-1 had only a viscosity of 3,620 mPa·s, whereby immediate curing is required to obtain coated layers exhibiting uniform thickness and surface evenness without the need for a grinding and polishing post-treatment. In cooling to 4° C. on plate A, the viscosity of the coated layer rapidly increases. The viscosity measured at 4° C. and at a shear rate of 10 s⁻¹ is 14,340 mPa·s or clearly above the minimum viscosity ηₘᵢₙ.

### Example 2

This example illustrates that sleeves with coated layers of uniform thickness and surface evenness can be produced at room temperature by increasing the coating temperature.

### Preparation of Coating Liquid

The radiation curable coating liquids LIQ-2 and LIQ-3 were prepared according to Table 4. The weight % (wt %) was based on the total weight of the radiation curable coating liquid. The second column shows the viscosity of the different components used in LIQ-2 and LIQ-3.

TABLE 4

| | | | LIQ-2 | |
|---|---|---|---|---|
| Component | Viscosity (mPa · s) | | (wt %) | LIQ-3 (wt %) |
| BR-7432 | 80,000 | at 25° C. | 40.8 | — |
| BR-7432G | 72,000 | at 25° C. | — | — |
| CN9001 | 46,000 | at 60° C. | 17.0 | — |
| CN9200 | 170,000 | at 25° C. | 15.0 | 30.0 |
| CN9800 | 40,000 | at 25° C. | — | 42.0 |
| SR531 | 13 | at 25° C. | 6.3 | 6.5 |
| SR285 | 6 | at 25° C. | 3.1 | 3.3 |
| SR340 | 10 | at 25° C. | 5.1 | 5.2 |
| GENOMER ™ 1122 | 20 to 50 | at 25° C. | 5.1 | 5.2 |
| MIRAMER ™ M100 | 47 | at 25° C. | 5.1 | 5.2 |
| IRGACURE ™ 651 | solid | at 25° C. | 2.5 | 2.6 |

The radiation curable coating liquids LIQ-2 and LIQ-3 have a viscosity as shown in Table 5 at 25° C. and at 40° C.

TABLE 5

| | |
|---|---|
| Coating | Viscosity (Pa · s) |

| Liquid | at 25° C. | at 40° C. |
|---|---|---|
| LIQ-2 | 36.0 | 8.9 |
| LIQ-3 | 7.1 | 2.0 |

### Coating and Evaluation of Flow Down Behaviour of Coating Liquids

The radiation curable coating liquids LIQ-2 and LIQ-3 were coated at a coating temperature of 40° C. They were coated horizontally at a thickness of 600 μm on an un-subbed glass plate having room temperature (20° C.) and a thickness of 2 mm. The coated glass plates were kept at 20° C. and placed vertically immediately after being coated. The flow down behaviour was followed in function of time. The results of the flow down behaviour are shown in Table 6.

TABLE 6

| | |
|---|---|
| Time after plate | Flow down |
| been put | displacement (cm) |

| vertically (min) | LIQ-2 | LIQ-3 |
|---|---|---|
| 0 | 0 | 0 |
| 1 | 0 | 0 |
| 2 | 0 | 0.1 |
| 3 | 0 | 1.0 |
| 4 | 0 | 2.0 |
| 8 | 0 | — |
| 10 | 0.1 | — |
| 12 | 0.2 | — |

No flow down was observed in the first minute after the plates coated with the radiation curable coating liquids LIQ-2 and LIQ-3 were put in a vertical position. The plate coated with LIQ-2, which exhibited the highest viscosity (8.9 Pa·s) at the coating temperature of 40° C., did not even show any flow down after 8 minutes. The plate coated with LIQ-3, which exhibited a viscosity of only 2.0 Pa·s at the coating temperature of 40° C., already started flow down after 2 minutes. The viscosity at different temperatures of LIQ-2 and LIQ-3 is shown in Table 7.

TABLE 7

Viscosity
(Pa · s)

| Temperature | LIQ-2 | LIQ-3 |
|---|---|---|
| 20° C. | 60.6 | 11.6 |
| 25° C. | 36.0 | 7.1 |
| 30° C. | 22.3 | 4.5 |
| 35° C. | 14.2 | 3.0 |
| 40° C. | 8.9 | 2.0 |
| 45° C. | 6.2 | 1.4 |
| 50° C. | 4.3 | 1.0 |
| 55° C. | 3.1 | 0.7 |
| 60° C. | 2.2 | 0.5 |

According to a preferred embodiment of the present invention, the minimum viscosity ηₘᵢₙ in this example where the coated layer has a thickness of 600 μm is 7,200 mPa·s. At the temperature of the plate at coating (20° C.), the radiation curable coating liquid LIQ-2 had a much higher viscosity than ηₘᵢₙ, resulting in more time available, before curing is required to obtain coated layers exhibiting uniform thickness and surface evenness without the need for a grinding and polishing post-treatment, than radiation curable coating liquid LIQ-3. It should be clear that reducing the temperature of the plate at coating below 20° C. will increase the time for the radiation curable coating liquid LIQ-3 before curing is required.

### Example 3

This example illustrates the relation according to a preferred embodiment of the present invention between the thickness of a coated layer and the minimum viscosity ηₘᵢₙ of the coating liquid at the surface temperature (see Eq.2).

### Preparation of Coating Liquid

The radiation curable coating liquids LIQ-4, LIQ-5 and LIQ-6 were prepared according to Table 8. The weight % (wt %) was based on the total weight of the radiation curable coating liquid. The second column shows the viscosity of the different components used in LIQ-4, LIQ-5 and LIQ-6.

TABLE 8

| | | | LIQ-4 | LIQ-5 | LIQ-6 |
|---|---|---|---|---|---|
| Component | Viscosity (mPa · s) | | (wt %) | (wt %) | (wt %) |
| BR-7432G | 72,000 | at 25° C. | — | — | 61.50 |
| CN9800 | 40,000 | at 25° C. | 66.00 | 42.00 | — |
| CN9200 | 170,000 | at 25° C. | — | 30.00 | — |
| SR531 | 13 | at 25° C. | 9.30 | 6.48 | 9.30 |
| SR285 | 6 | at 25° C. | 4.70 | 3.27 | 4.70 |
| SR340 | 10 | at 25° C. | 7.50 | 5.23 | 7.50 |
| GENOMER ™ | 20 to 50 | at 25° C. | 1.50 | 5.23 | 5.50 |
| 1122 | | | | | |
| MIRAMER ™ | 47 | at 25° C. | 7.50 | 5.23 | 7.50 |
| M100 | | | | | |
| IRGACURE ™ 651 | solid | at 25° C. | 3.70 | 2.56 | 3.70 |

The radiation curable coating liquids LIQ-4, LIQ-5 and LIQ-6 have a viscosity as shown in Table 9 at 25° C. and at 40° C.

TABLE 9

| | |
|---|---|
| Coating | Viscosity (Pa · s) |

| Liquid | at 20° C. | at 40° C. |
|---|---|---|
| LIQ-4 | 2.59 | 0.64 |
| LIQ-5 | 11.63 | 1.96 |
| LIQ-6 | 29.71 | 6.12 |

### Coating and Evaluation of Flow Down Behaviour of Coating Liquids

The radiation curable coating liquids LIQ-4, LIQ-5 and LIQ-6 were coated at a coating temperature of 40° C. They were coated horizontally at a coating thickness (d) as indicated in table 10 on an un-subbed glass plate having room temperature (20° C.) and a thickness of 2 mm. The coated glass plates were kept at 20° C. and placed vertically immediately after being coated. The flow down behaviour was followed in function of time (minutes). The results of the flow down behaviour are shown in Table 10.

TABLE 10

| | Flow down displacement (cm) | | | | |
|---|---|---|---|---|---|
| Time after | d = 290 μm | d = 600 μm | | d = 980 μm | |
| plate been | ηmin = 1.8 Pa · s | ηmin = 7.2 Pa · s | | ηmin = 20.0 Pa · s | |
| put | LIQ 4 | LIQ 4 | LIQ 5 | LIQ 5 | LIQ 6 |
| vertically | η (20° C.) > | η (20° C.) < | η (20° C.) > | η (20° C.) < | η (20° C.) > |
| (min) | ηmin | ηmin | ηmin | ηmin | ηmin |
| 0 | 0 | 0 | 0 | 0 | 0 |
| 1.00 | 0 | 6.0 | 0 | 5.0 | 0 |
| 1.25 | 0 | >8.0 | — | >8.0 | — |
| 1.50 | 0.7 | — | 0 | — | 0 |
| 1.75 | 1.5 | — | — | — | — |
| 2.00 | 2.5 | — | 0.5 | — | 0.3 |
| 3.00 | — | — | 2.0 | — | 2.0 |
| 4.00 | — | — | 3.0 | — | 3.0 |

In Table 10, the minimum viscosity ηₘᵢₙ has been calculated according to the present invention (Eq.2) for each coating thickness. It is clear from the flow displacement measurements that those coatings of which the coating liquid has a viscosity (at the temperature of the surface of the glass plate) above the minimum viscosity calculated for the coating thickness used, the flow down is much less compared to those coatings of which the coating liquid has a viscosity below the minimum viscosity calculated for the coating thickness used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-15. (canceled)

16. A method of coating a peripheral surface of a sleeve core with a radiation curable coating liquid, the method comprising the steps of:
supporting the sleeve core in a vertical position coaxial with a coating axis;
providing an annular coating collar;
supplying the radiation curable coating liquid to the annular coating collar and moving the annular coating collar along the sleeve core in a vertical direction coaxial with the coating axis, thereby coating a layer of the radiation curable coating liquid onto a peripheral surface of the sleeve core; wherein
the coated layer of the radiation curable coating liquid is cooled by the peripheral surface of the sleeve core to have a viscosity at a temperature of the peripheral surface of the sleeve core and at a shear rate of 10 s⁻¹ larger than a minimum viscosity ηₘᵢₙ, wherein:
$${η}_{min} = \frac{{d}^{2}}{50}$$
and
d represents a thickness of the coated layer in μm; and
ηₘᵢₙ is expressed in mPa·s.

17. The coating method according to claim 16, wherein the peripheral surface of the sleeve core has a temperature which is at least 10° C. lower than a coating temperature of the radiation curable coating liquid.

18. The coating method according to claim 16, wherein the peripheral surface of the sleeve core has a temperature above the dew point.

19. The coating method according to claim 17, wherein the peripheral surface of the sleeve core has a temperature above the dew point.

20. The coating method according to claim 16, wherein the radiation curable coating liquid has a temperature of at least 40° C.

21. The coating method according to claim 17, wherein the radiation curable coating liquid has a temperature of at least 40° C.

22. The coating method according to claim 19, wherein the radiation curable coating liquid has a temperature of at least 40° C.

23. The coating method according to claim 16, wherein the radiation curable coating liquid has a viscosity of 100 to 50,000 mPa·s at the coating temperature and at a shear rate of 10 s⁻¹.

24. The coating method according to claim 17, wherein the radiation curable coating liquid has a viscosity of 100 to 50,000 mPa·s at the coating temperature and at a shear rate of 10 s⁻¹.

25. The coating method according to claim 19, wherein the radiation curable coating liquid has a viscosity of 100 to 50,000 mPa·s at the coating temperature and at a shear rate of 10 s⁻¹.

26. The coating method according to claim 22, wherein the radiation curable coating liquid has a viscosity of 100 to 50,000 mPa·s at the coating temperature and at a shear rate of 10 s⁻¹.

27. The coating method according to claim 16, wherein the radiation curable coating liquid includes:
a) a photoinitiator;
b) a urethane (meth)acrylate oligomer having a viscosity of at least 1,000 mPa·s at 25° C. and at a shear rate of 10 s⁻¹; and
c) at least one (meth)acrylate based diluent.

28. The coating method according to claim 16, further comprising the step of:
providing an irradiation stage with actinic radiation.

29. The coating method according to claim 27, further comprising the step of:
providing an irradiation stage with actinic radiation.

30. The coating method according to claim 28, further comprising the step of:
moving the irradiation stage in synchronism with the annular coating collar along the sleeve core in the vertical direction while irradiating the coated layer of the radiation curable coating liquid so as to at least partially cure the coated layer of the radiation curable coating liquid onto the peripheral surface of the sleeve core.

31. The coating method according to claim 29, further comprising the step of:
moving the irradiation stage in synchronism with the annular coating collar along the sleeve core in the vertical direction while irradiating the coated layer of the radiation curable coating liquid so as to at least partially cure the coated layer of the radiation curable coating liquid onto the peripheral surface of the sleeve core.

32. The coating method according to claim 16, further comprising:
repeating the step of moving the coating collar a plurality of times so as to apply a plurality of the coated layers of the radiation curable coating liquid onto the peripheral surface of the sleeve core.

33. The coating method according to claim 28, further comprising:
repeating the step of moving the coating collar a plurality of times so as to apply a plurality of the coated layers of the radiation curable coating liquid onto the peripheral surface of the sleeve core.

34. The coating method according to claim 30, further comprising:
repeating the step of moving the coating collar a plurality of times so as to apply a plurality of the coated layers of the radiation curable coating liquid onto the peripheral surface of the sleeve core.

35. A method of making a flexographic printing master comprising the steps of:
a) coating a peripheral surface of a sleeve core with a radiation curable coating liquid according to claim 16; and
b) forming a relief onto or from the coated layer.

36. A method of making a flexographic printing master comprising the steps of:
a) coating a peripheral surface of a sleeve core with a coating liquid according to claim 27; and
b) forming a relief onto or from the coated layer.

37. The method of making a flexographic printing master according to claim 35, wherein the step of forming the relief includes image wise exposing the coated layer with actinic radiation or direct laser engraving a fully cured coated layer.

38. The method of making a flexographic printing master according to claim 35, wherein the step of forming the relief includes jetting the relief onto an at least partially cured coated layer with an inkjet.

39. A coating device arranged to coat a peripheral surface of a sleeve core with a radiation curable coating liquid, the coating device comprising:
a vertical support column arranged to support the sleeve core in a vertical position coaxial with a coating axis; and
a coating stage including a carriage arranged to slide along the vertical support column, and an annular coating collar mounted on the carriage and moveable therewith, the annular coating collar arranged to contain the radiation curable coating liquid and to coat a layer of the radiation curable coating liquid onto a peripheral surface of the sleeve core during a sliding movement of the carriage along the vertical support column, the annular coating collar positioned coaxial with the coating axis; wherein
the coating device further includes a cooling device arranged to cool the peripheral surface of the sleeve core.

40. The coating device according to claim 39, further comprising a heating device arranged to heat the radiation curable coating liquid.

41. The coating device according to claim 39, further comprising an irradiation stage arranged to provide radiation to at least partially cure the coated layer of the radiation curable coating liquid onto the peripheral surface of the sleeve core.

42. The coating device according to claim 40, further comprising an irradiation stage arranged to provide radiation to at least partially cure the coated layer of the radiation curable coating liquid onto the peripheral surface of the sleeve core.
